(19) United States
(12) Patent Application Publication
(10) Pub. No.: US 2005/0100714 A1
(43) Pub. Date: May 12, 2005

(54) Cushioning material

(75) Inventors: William Francis Sutcliffe, Mt. Eliza (AU); Rohitendra Kumar Singh, Werribee (AU); Michael Andrzej Sek, St. Kilda (AU)

Correspondence Address: FISH & RICHARDSON P.C., 1425 K STREET, N.W., 11TH FLOOR, WASHINGTON, DC, 20005-3500, US

(73) Assignees: Micor Packaging Pty Ltd, an Australian corporation; Vision Products Pty Ltd, an Australian corporation; Michael Andrzej Sek

(21) Appl. No.: 10/653,145

(22) Filed: Sep. 3, 2003

Related U.S. Application Data
(63) Continuation of application No. 09/721,665, filed on Nov. 27, 2000, now abandoned.

(30) Foreign Application Priority Data
Nov. 26, 1999 (AU) PQ4273/99

(51) Int. Cl. B32B 3/28

(52) U.S. Cl. 428/184; 156/210

(57) ABSTRACT

A method of making cushioning material including the steps of forming a plurality of alternate layers of flat and corrugated sheets of cardboard or paper which are bonded or glued together, curing or drying the bonding material or glue, crushing the layers so that at least a predetermined portion of the layers are plastically deformed to thereby form a block of cushioning material which behaves like an elastic body.

This invention relates to cushioning material which can be used for packing of articles.

When articles are being packed for transport, it is quite common to use a cushioning material between the outer container and the article. This is especially so where the article is fragile.

Various types of materials have been used for this purpose and these include foamed plastics material and cardboard material in the form of blocks or sheets of multi-layered corrugated cardboard or paper or the like.

When a multi-layered cardboard body is used as the packing or cushioning material, it tends to be initially quite rigid. In use, however, if the container is subjected to a drop or crushing action the cardboard collapses and typically there would then be a gap between the outer container and the article because the cushioning material plastically deforms to a more compressed state. Once this occurs the effectiveness of the packing material is very significantly reduced and the article is susceptible to damage if there is any repeated dropping or crushing action on the container.

Australian Patent No. 687402 refers to making of packaging material using corrugated cardboard which is compressed so that the material exhibits resilience. The packaging material disclosed in that specification, however, is formed by winding a sheet of corrugated paper and a sheet of plain paper into a roll and then pressing the roll f material into a shape and permitting an adhesive to set whereby the material remains in the desired shape. The material produced in this form is usually cut using a bandsaw. The resultant material is of low grade making it unsuitable for packing high quality or dust sensitive products. It also has a low quality appearance.

An object of the present invention is to provide a novel form of cushioning material which behaves essentially like an elastic body, has a high quality appearance and is suitable for packaging of a wide variety of articles.

According to the present invention there is provided a method of making cushioning material including the steps of forming a plurality of alternate layers of flat and corrugated sheets of cardboard or paper which are bonded or glued together, curing or drying the bonding material or glue, crushing the layers so that at least a predetermined portion of the layers are plastically deformed to thereby form a block of cushioning material which behaves like an elastic body.

The invention also provides a packaged article including a container, an article in the container and cushioning material located between the container and the article characterised in that the cushioning material comprises corrugated cardboard which has been crushed by a predetermined amount whereby the cushioning material essentially behaves like an elastic body.

Preferably the cushioning material initially engages both the container and the article so that if compression of the cushioning material occurs, it will resiliently expand so that it will remain in contact with both the container and the article.

The invention also provides a block of cushioning material including a plurality of alternate layers of flat and corrugated sheets of cardboard or paper each having weights in the range 85 gsm to 115 gsm and being bonded or glued together, the layers being crushed so that the corrugated sheets are plastically deformed to thereby form a block of cushioning material having upper and lower surfaces which are substantially planar and wherein the block behaves like an elastic body.

The invention will now be further described with reference to the accompanying drawings, in which:

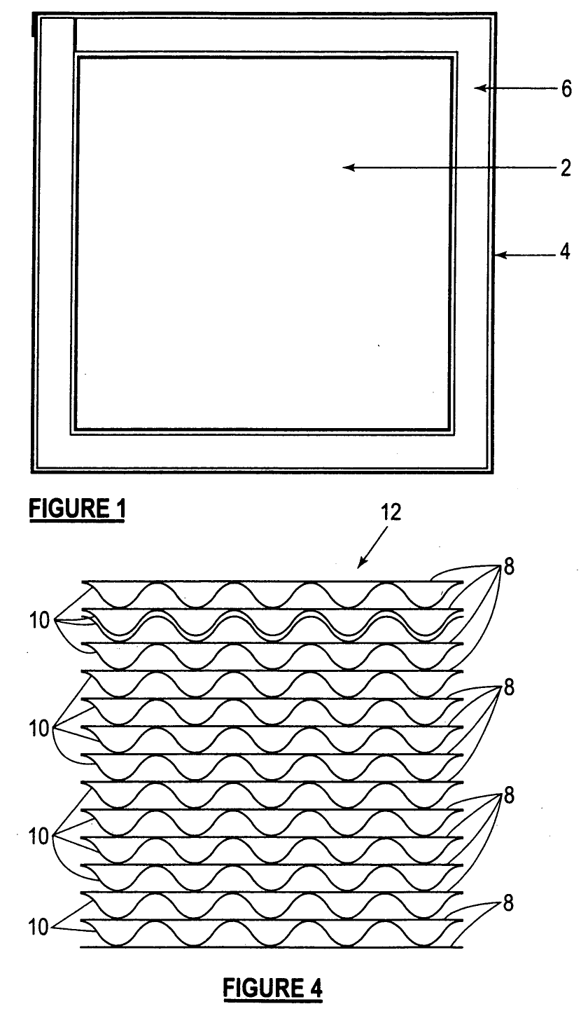

FIG. 1 is a schematic view of an article in a container;

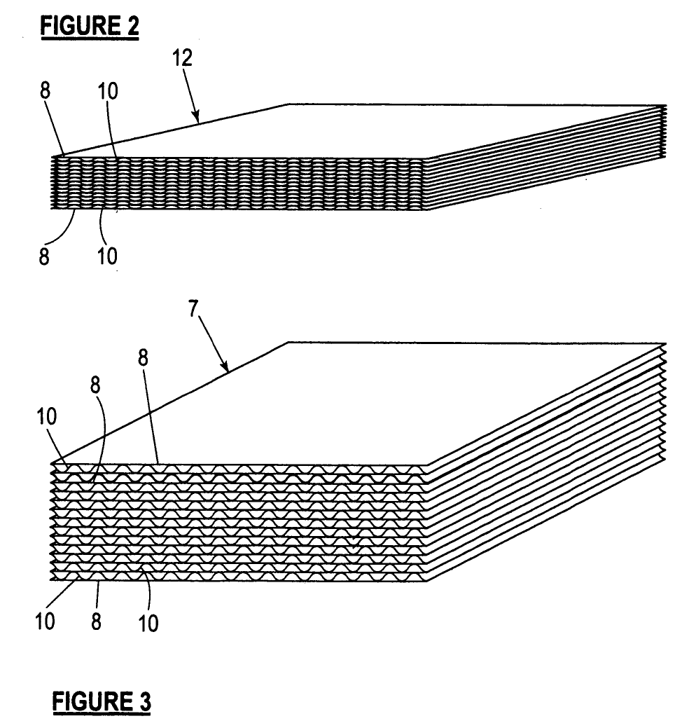

FIG. 2 is a schematic view of a block of cushioning material fully crushed;

FIG. 3 is a schematic view of a block of cushioning material of the invention;

FIG. 4 shows an end view of a block of cushioning material of the invention;

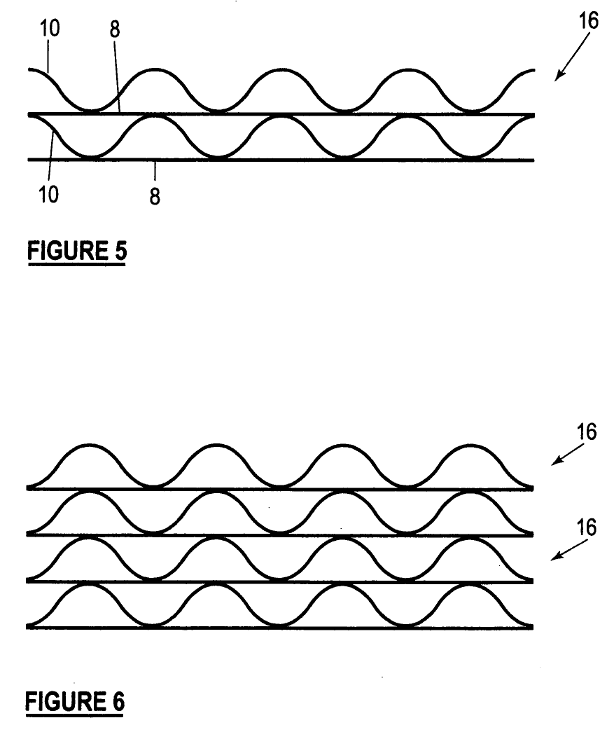

FIGS. 5 to 8 show typical steps in forming the cushioning material;

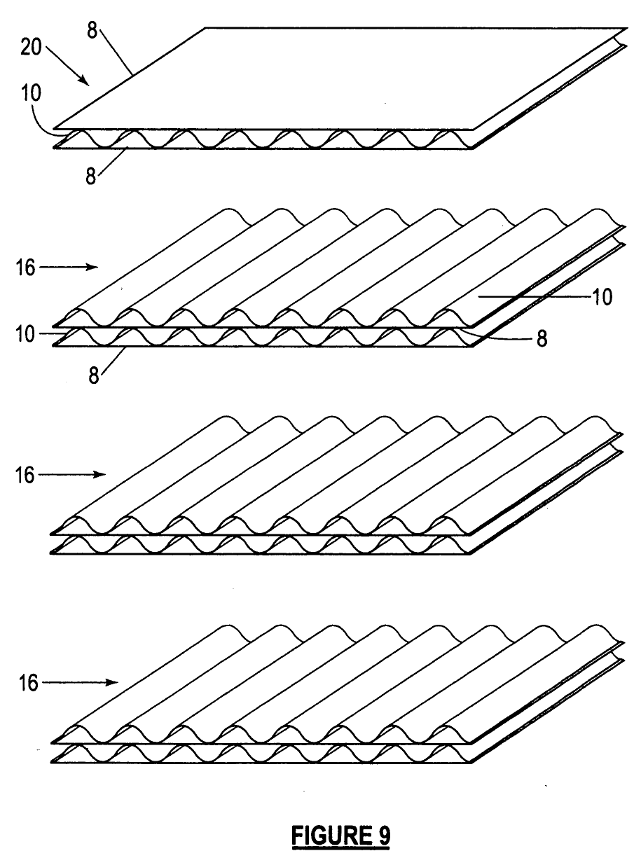

FIG. 9 is a schematic view showing a modified technique for forming the cushioning material;

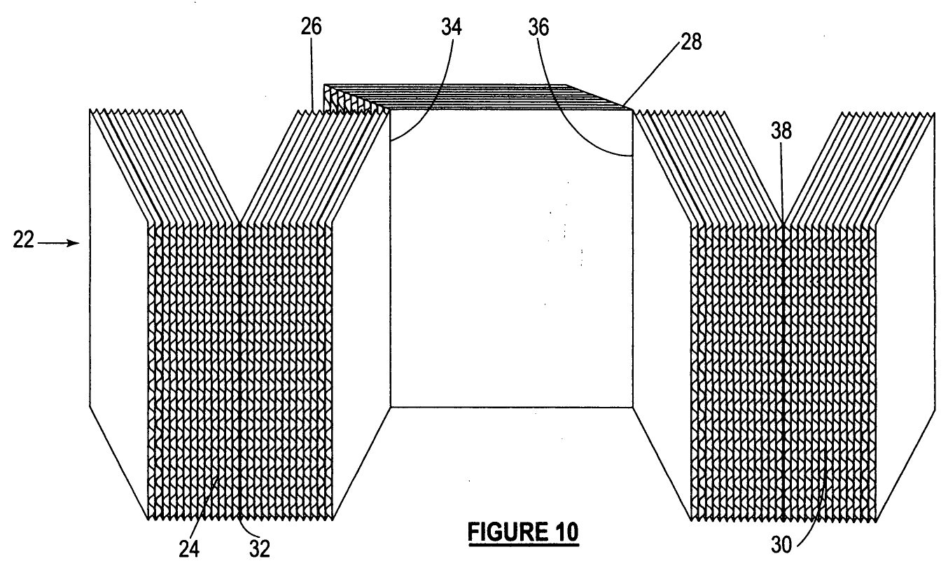

FIG. 10 is a schematic view of the cushioning material cut in a particular way;

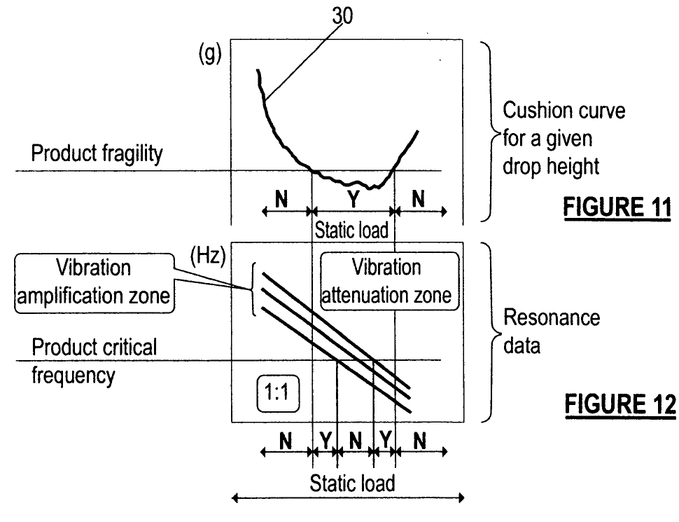

FIG. 11 is a graph showing the relationship between fragility and static load;

FIG. 12 is a graph showing vibration of frequency as a function of static load;

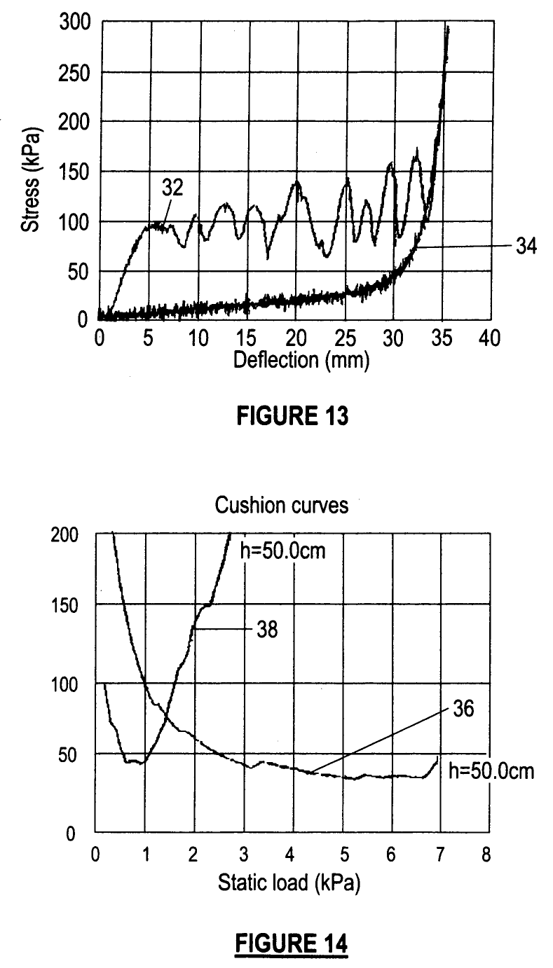

FIG. 13 shows the stress deflection characteristics of the cushioning material; and

FIG. 14 is another graph illustrating the performance of the cushioning material.

FIG. 1 schematically illustrates an article 2 located within an outer container 4. The outer container 4 may be in the form of a cardboard or wooden crate or other suitable container. A layer of cushioning material 6 is located between the article and the container. In the illustrated arrangement, the material 6 extends fully about the article but in accordance with known practice the cushioning material may be located at selected locations between the container 4 and the article 2. It is preferable, however, that there are no, or relatively few, gaps between the cushioning material and the article and the container. In other words, where the cushioning material is present, it is a snug fit between the article 2 and the container 4.

FIG. 3 shows a schematic view of a block 7 of the cushioning material 6 of the invention. It includes a plurality of flat sheets 8 of paper or cardboard between which are interposed crushed corrugated layers 10. The layers 10 are also formed from paper or cardboard. As shown in FIG. 3, there is a sheet 8 located on the top and bottom faces of the material. This gives the material a relatively attractive appearance which is better than if one of the corrugated layers 10 were on an outer face of the material.

It is preferred that sheet 8 and corrugated layer 10 be made from recycled paper or cardboard having a grade in the range 85 to 115 gsm and preferably 112 gsm. It can be made from recycled material or it could be made from virgin pulp.

A block 7 of cushioning material of the invention is preferably made by initially forming a body 12 as shown in FIG. 4. The body 12 essentially comprises alternate layers of the sheets 8 and corrugated layers 10 but in this state, the corrugations are essentially sinusoidal. The crests of the corrugations in the layers 10 are bonded to the adjacent sheets 8. This can bc effected by using a water based glue such as those which are typically used for forming corrugated cardboard or multi-layer corrugated cardboard bodies, for example pva glue. The bonding material or glue is preferably applied to the crests of the corrugations by means of a roller (not shown) or the like. Preferably the material is passed between a pair of rollers, one of which applies bonding material to th crests of the flutes, the axes of the rollers being parallel to the longitudinal direction of the corrugations. During the curing or drying stage, it is preferred that uniform pressure is applied to the layers so that they maintain their flat shape and that the corrugations also maintain their initial shape. The dimensions of the body 12 are determined by the lengths and widths of the sheets 8 and by the number of layers.

Once the body 12 has been made and the glue permitted to dry, it can, in accordance with the invention, be crushed by a predetermined amount in order to produce the cushioning material 6 of the invention. The crushing can be accomplished by passing the body 12 through compression rollers (not shown). FIG. 2 diagrammatically shows the cushioning material fully compressed. The fully compressed material will partially recover to form the essentially elastic body 7 as shown in FIG. 3. The rollers may include cutting elements to simultaneously cut the outer shape of the material so that it can be efficiently used in a container 4. In some circumstances, some of the layers may be cut. Appropriate cutters can be used on the compression rollers to simultaneously produce the required shaping of the body 7. It will be appreciated that the body 7 is cuboid in shape and has upper and lower faces which are parallel to the sheets 8 therein.

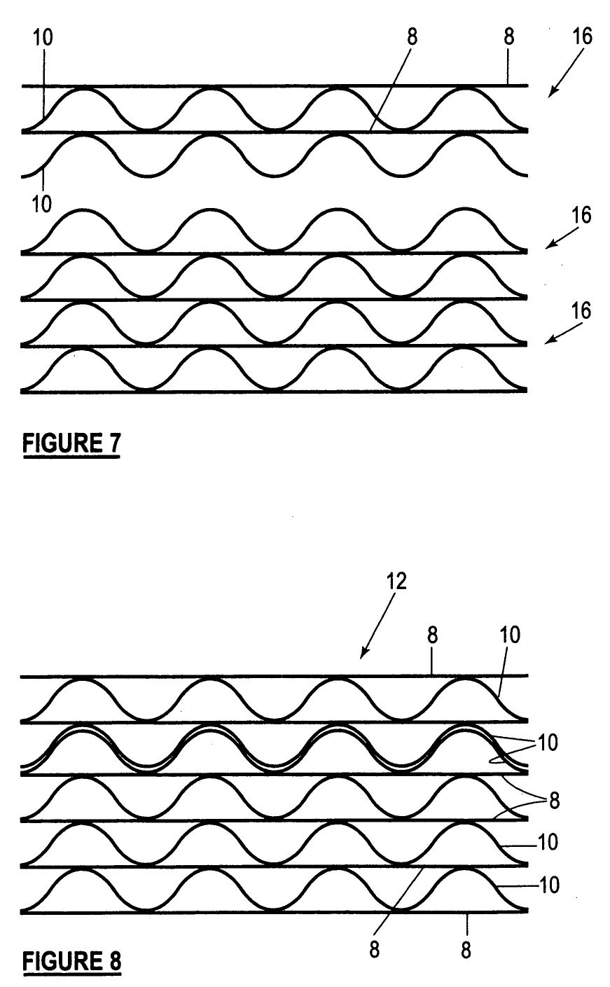

FIGS. 5 to 8 show typical steps in formation of the body 12. FIG. 5 schematically shows part of a composite layer 16 of double corrugated material which is readily available from various manufacturers. This composite material is a useful starting material because it is relatively rigid which facilitates handling of the material through laminating machinery and the like. The composite layer 16 includes two of the sheets 8 and two of the corrugated layers 10. Two of the composite layers 16 can be bonded together, as shown in FIG. 6. This is preferably accomplished by applying a water-based glue to the crests of the corrugations and then passing the two composite layers 16 through a laminating roller and drying the glue. This procedure can be repeated in order to make a body 12 of the desired thickness. When the penultimate layer has been laminated, it is preferred to invert the uppermost layer as shown in FIG. 7 so that its sheet 8 is above its corrugated layer 10. It can then be glued to the juxtaposed corrugated layer 10, as shown in FIG. 8. In this way the body 12 has a flat sheet 8 on its upper and lower surfaces. After all the layers have been laminated to form the body 12, the body 12 or a stack of bodies 12 are placed in a press to apply uniform pressure and cured in the press in order to produce well defined slabs of cushioning material.

FIG. 9 schematically shows an alternative arrangement for forming the body 12. In this arrangement, a number of composite layers 16 are glued together and a top layer 20 is then applied. The top layer 20 has a corrugated layer 10 sandwiched between upper and lower sheets 8. The top layer 20 is glued to the uppermost composite layer 16 so that the resulting body has a flat sheet 8 on its upper and lower surfaces, as before. The sheets 8 and 10 in the top layer 20 are preferably made from paper having a weight in the range 105 gsm to 112 gsm.

Once the body 12 has been made and the glue dried or cured, it can then be crushed by a predetermined amount or by predetermined amounts in selected areas so as to form the cushioning material 6 of the invention. The crushing is preferably carried out by passing the body 12 through rollers. The amount of compression of the body 12 can be varied in accordance with the amount of precompression of the corrugated layers. When a multi-layer block is compressed, it tends to compress the corrugated layers on the outsides of the sheet. If the degree of compression is relatively small, only a few of the outer corrugated layers 10 will be crushed whereas those in the centre form a core of material in which the layers 10 have the corrugations intact. Accordingly, by selecting the degree of crushing for the body 12, the number of crushed layers 10 can be varied to a considerable degree from the situation where just the outermost layers 10 are crushed to an extreme situation where all of the layers 10 are crushed. The ability to selectively crush some of the layers 10 whilst leaving the central layers 10 uncrushed provides an opportunity to create a cushioning material which has a predetermined balance between cushioning and stiffness. The uncrushed layers can be provided in some circumstances where lower deceleration forces are required.

FIG. 2 shows the body 12 fully crushed. After crushing the material will expand somewhat to form the essentially elastic block 7 of cushioning material as shown in FIG. 3.

In the material of the invention, the layers are flat and planar resulting in the formation of a cuboidal block 7 of cushioning material. The block can be cut using a knife or the like in order to form shaped cushioning elements. Because of the grade of paper or board which is used, and the fact that a knife is used, the spaces between the corrugations constitute air paths which are open and not obstructed by fragments of the material. This results in superior resilience of the material.

It has been found that the use of a knife to cut the material produces a clean cut through the material or part way through the material. This leaves air passages through the corrugated layers open. It has been found that this enhances the elastic properties of the material. In contrast, if a saw or the like were used to cut the material, fragments of paper would tend to clog the ends of the air passages in the corrugated layers and this produces a product with inferior cushioning properties. Also, the product has a poor appearance and would not be suitable for packaging of high value products.

FIG. 5 shows a block 22 of cushioning material which includes transverse knife cuts 24, 26, 28 and 30. In the illustrated arrangement, the cuts are transverse to the corrugations but do not extend all the way through the block of material so as to define integral hinges 32, 34, 36 and 38. The block 22 can be shaped so that various parts thereof can be selectively positioned about a product to be packaged. It will be appreciated that the material can be used in a very flexible way. It is also dust free because the use of a knife or like to form the cuts minimises production of dust.

The cushioning material 6 of the invention behaves like an essentially elastic body. This enables computation to a reasonable degree of accuracy of the amount of packaging material of the invention required to achieve a desired cushioning result as explained below.

In this procedure, the amount of shock which a product can withstand must first be determined. This is known as the “fragility factor” or “g-factor”. Fragility is expressed in units of “g” which is the maximum deceleration the product can withstand without damage. The more fragile a product, the lower its g-factor, as the typical values in Table 1 show.

TABLE 1

| Fragility | Product | g-factor | |
|---|---|---|---|
| Extremely Fragile | Aircraft Altimeters, gyroscopes | 15-25 | g |
| Very Delicate | Medical diagnostic apparatus | 25-40 | g |
| Delicate | Printers, Display terminals, | 40-60 | g |
| | test instruments, hard disc drives | | |
| Moderately Delicate | Stereos & televisions | 60-85 | g |
| Moderate | Major appliances | 85-115 | g |
| Rugged | Table saws, sewing machines | <115 | g |

Step 1

The fragility of a product is determined by performing the fragility test whereby the product is subjected to a series of gradually increasing shocks (decelerations) in order to find the lowest severity impact which will damage the product. The highest deceleration which does not cause damage is then known as the g-factor for the product. It may be necessary to determine fragility levels for a product in various orientations as the product may exhibit greater strength in one direction than another.

If the g-factor is estimated too high the product will incur damage as the packaging will be under-designed. Alternatively, if the g-factor estimation is too low, the product will withstand greater shock but the packaging will be over-designed and unnecessarily expensive.

Step 2

To establish the amount of shock the product may encounter it is necessary to determine the height from which the product may be dropped in normal handling and transportation processes for the product.

Approximate drop heights can be established by the weight of the product. The following table shows typical drop heights based on weight. However, specific information on the handling process will usually be more accurate.

TABLE 2

| Weight Range | | Type of Handling | Drop Height |
|---|---|---|---|
| 0-1.5 | kg | 1 person throwing | 2 metre |
| 1.5-9 | kg | 1 person carrying | 1 metre |
| 9-22 | kg | 1 person carrying | 750 mm |
| 22-45 | kg | 2 persons carrying | 600 mm |
| 45-110 | kg | Light equipment | 450 mm |
| 110 | kg plus | Heavy equipment | 300 mm |

Cushioning Material Test

When product fragility (g-factor) and handling process (drop height) have been determined, the following procedure can be used to establish the amount of functional cushioning materials required.

Functional cushioning material means the proportion of the total cushioning material which directly supports the load and functions to absorb shock during impacts.

There may be additional material used in the design or layout of the cushioning material to interconnect function in parts thereof as well as the outer carton etc. Generally, these effects will enhance product protection so the cushioning material test can normally be confidently used as the starting point.

To calculate functional cushioning needs it is necessary to use and understand dynamic cushioning curves. A cushion curve shows how a particular packaging material performs at various impact conditions. Curves are usually generated by dropping a known weight onto the cushion sample from a range of specific heights and measuring the amount of shock experienced by the weights as they impact the cushion.

The cushioning curve shown in FIG. 9 represents the cushioning performance of a material for a given combination of material thickness and drop height. The horizontal axis represents a range of static loadings (in kpa) that weight might apply to the cushioning material. The vertical axis represents the shock experienced by the weight as the cushioning material is impacted.

Normally the method of determining suitable cushioning material for performance criteria is to test a range of products with various cushioning materials. From the results of these tests, each material can be graded according to its performance. It is noted that for known cushioning materials such as foamed polyethylene, there are many different grades of materials available which can lead to relatively high inventory costs if stocks of different grades of cushioning material are to be stored. On the other hand, with the cushioning material of the invention, only a singly type of material needs to be kept and its cushioning properties can be selected to provide the required cushioning characteristics by choosing the amount of precompression the material is subjected to.

Product Sensitivity Tests

1. Product Fragility Test can be performed to determine peak acceleration (g). This establishes the breaking point of the product for protection.
2. Product Vibration Test can be performed to identify the frequency at which a component of the product will resonate. The result reflects the point of vibration to which the product should not be subjected. Typical graphical results are shown in FIG. 10.
   Cushioning Material Tests
1. A Static Load Test can be used to create a curve graph showing the level of cushioning provided by the cushioning material over a range of drop height levels.
2. A Vibration Transmissibility Test can be used to create resonance frequency data that measures the vibration control level provided by the cushioning material.

Through the performance of the cushioning material tests described, it has been found that the level of compression applied to the material under study, will effect the cushioning and vibration curve attained therefore modifying the level of protective cushioning provided.

Repeat tests performed have demonstrated that the cushioning material of the invention maintains its protective characteristics on a continual basis because of its quasi-elastic behavioural properties.

Some examples of computations are set out below relating to calculation of the resonance frequency and stiffness together with the amount of cushioning material required to achieve desired parameters.

### EXAMPLE 1

A 9 kg product on a cushion has a natural frequency of 5 Hz. In order to calculate the amount of weight on cushioning material which needs to be added to the product to reduce its natural frequency to 4 Hz, where:
K=Stiffness
f=frequency (Hz)
M=Mass (Kg)
m=metre

First calculate the stiffness K

$$\begin{matrix}f = \frac{1}{2 π} \sqrt{\frac{K}{M}} \\ \begin{matrix}K = {( 2 π f )}^{2} \times M \\ = {( 2 π x 5 )}^{2} \times 9 \\ = 8951.7 \frac{N}{m}\end{matrix}\end{matrix}$$

Add mass so that natural frequency is 4 Hz

$$\begin{matrix}M = \frac{K}{4 {π}^{2} {f}^{2}} \\ = \frac{8951.7}{4 {π}^{2} \times 16} \\ = 14.16 Kg \\ = 138 N \\ 138 N - 89 N = 49 N\end{matrix}$$

therefore 49N or 4.9 kg needs to be added to reduce the natural frequency to 4 Hz.

### EXAMPLE 2

An 89N product on a cushion has a natural frequency of 13 Hz. If 111N is added to the product's weight and the product is placed on three of these cushions in series, the following method can be used to calculate the new natural frequency.
(Weight=89 Newtons, M−89/9.81=9.07 kg, Frequency=13 Hz)

$$\begin{matrix}fn = \frac{1}{2 π} \sqrt{\frac{K}{M}} \\ ∴ K = {( 2 π f )}^{2} \times M \\ = {( 2 π x 13 )}^{2} \times 9.07 \\ = 60513 \frac{N}{m}\end{matrix}$$

Assuming there are three layers of cushioning material in series, i.e. stacked upon one another having stiffnesses K₁, K₂ and K₃, then:

$$\begin{matrix}\frac{1}{{K}_{eq}} = \frac{1}{{K}_{1}} + \frac{1}{{K}_{2}} + \frac{1}{{K}_{3}} \\ ∴ {K}_{eq} = 20171 \\ ∴ f = \frac{1}{2 π} \sqrt{\frac{20171}{20.4}} \\ = 5 Hz\end{matrix}$$

Design of Protective Cushioning

Characteristics relevant to the application of cushioning material in protective packaging for transportation include: (i) cushion curves, (ii) a behaviour in consecutive impacts, (iii) critical resonance frequency, (iv) vibration transmissibility amplification and attenuation, and (v) dynamic and static creep.

The shock transmitted to a product depends strongly on the static load, i.e. the weight of the product divided by the cushion bearing area. A cushion curve shows the peak values of shock acceleration (usually expressed in g's) as a function the static load (usually expressed in kPa) in an impact from a given drop height. There is an optimum static load for which the shock is at minimum. In the process of design of protective packaging a range of static loads is selected for which the acceleration is below the product critical acceleration or g-fragility. The range is marked ‘Y’ on the cushion curve 30 shown in FIG. 9. The design must ensure that the bearing area of the cushion produces the static load within that range.

In order to provide a cushioning effect in an impact a cushion must deform. The deformation can be elastic, plastic of a combination thereof. Predominantly plastic deformation leads to a reduction in thickness and consequently to the worse performance in consecutive impacts and a deterioration of the containment function of the package. For these reasons it is preferred that the deformation of a cushioning material is mainly elastic. Deformation of known forms of corrugated paperboard media of typical flute geometry is mainly plastic. In sharp contrast, deformation of the material 6 of the invention is mainly elastic.

A product-cushion system constitutes a vibratory system with the resonance frequency (Hz) and the vibration amplification region depends strongly on the static load. If a component of the product exhibits the resonance at a certain frequency the package design should ensure that these frequencies do not coincide, by eliminating a certain range of static load otherwise allowable for shock protection purposes. This is indicated by the two zones marked Y in the graph of FIG. 10.

Modification of the Compression Characteristics

Behaviour of a cushion pad is related to its compression characteristics (compressive stress versus deflection) and its stiffness. In this invention the compression characteristics of the corrugated medium is modified by inducing the plastic deformations prior to using it as a cushion in such a way that it becomes mainly elastic and with reduced stiffness. As an illustration, FIG. 11 shows curves 32 and 34 respectively of the compression characteristics of an unmodified and modified pad of material of the invention of similar initial thickness. Individual layers of corrugated medium collapsing plastically cause the fluctuation of stress in the unmodified pad. The stiffness of the modified pad of material of the invention is much smaller and the pad restores well to its original thickness as opposed to the unmodified pad.

FIG. 12 diagrammatically shows a cushion curve 36 for a pad of cushioning material of the invention and a cushioning curve 38 for an unmodified pad. These curves are for the first drop from a height of 0.5 metres. It can be demonstrated that in order to match the shock protective performance of the pad of the invention, the unmodified pad would have its thickness reduced by about 25% in the first impact. While the cushioning curve and thickness of the pad of the invention remains practically the same after consecutive drops, the performance of the unmodified pad significantly deteriorates, as can be seen from a comparison of the curves 36 and 38.

It will be appreciated by those skilled in the art that the cushioning material of the invention has a number of advantages over known cushioning materials. The material has the following favourable properties.
1. It is relatively inexpensive.
2. It is relatively light weight.
3. It is biodegradable.
4. It is essentially elastic.
5. It can readily be incorporated into cushions or pads which have specific properties.
6. It has high compressive strength if used along the edge of an article or outer container.
7. The stiffness can be accurately determined which enables the resonant frequency of a product with attached cushioning material to be readily calculated.
8. It has an attractive appearance which means that it can be used for packing of high quality goods.
9. It is essentially dust free.

Many modifications will bc apparent to those skilled in the art without departing from the spirit and scope of the invention.

1-5. (canceled)

6. A method as claimed in claim 18 wherein the sheets of cardboard or paper have a weight in the range 85 gsm to 115 gsm.

7. A method as claimed in claim 22 wherein the sheets of cardboard or paper which are used in said top layer of board material have a weight in the range 105 gsm to 112 gsm.

8. A method as claimed in claim 18 including of applying uniform pressure to said layers during curing or drying of the bonding material or glue, the pressure being selected such that the fluted shapes of said corrugations is not altered during curing or drying.

9. A method as claimed in claim 17 wherein the layers are crushed by passing the layers between a pair of rollers.

10. A method as claimed in claim 9 wherein the spacing of the rollers is selected such that all the corrugated layers are fully crushed.

11. A method as claimed in claim 10 further comprising cutting the material with a knife or cutter to minimize production of particles of said cardboard or paper whereby air spaces in the corrugated layers are open.

12. Cushioning material made by the method of claim 18.

13-17. (canceled)

18. A method of making a body cushioning material from a plurality of layers of relatively rigid composite board material, each layer of relatively rigid composite board material comprising:
first, second, third and fourth sheets of cardboard or paper, the second and fourth sheets being corrugated and the second sheet being located between the first and third sheets and wherein all of the sheets are glued or bonded together to form said layer of relatively rigid composite board material, the method including:
applying glue or bonding material to layers of said composite board material;
stacking said layers in parallel relation to one another;
drying or curing the glue or bonding material to form a body of material; and
crushing the layers so that the second and fourth sheets are plastically deformed to thereby form a body of cushioning material which behaves like an elastic body.

19. A method as claimed in claim 18 wherein the glue or bonding material is applied to crests of corrugations of said fourth sheets.

20. A method as claimed in claim 19 further comprising laminating layers applying glue or bonding material thereto.

21. A method as claimed in claim 18, wherein a first sheet of a lowermost layer defines a lower surface of the body of cushioning material, the method further comprising placing an uppermost layer so that corrugations of a fourth sheet engage corrugations of an adjacent sheet whereby a first sheet of the uppermost layer defines an uppermost surface of the body of cushioning material.

22. A method as claimed in claim 18, wherein a first sheet of a lowermost layer defines a lower surface of the body of cushioning material, the method further comprising stacking a top layer of composite board material on said layers, wherein:
the top layer comprises first, second, third, fourth and fifth layers of cardboard or paper, and
the second and fourth sheets of the top layer are corrugated and located between the first and third sheets of the top layer and the third and fifth sheets of the top layer respectively such that the fifth sheet of the top layer defines the uppermost surface of the body of material.

23. A body of cushioning material comprising a plurality of layers of relatively rigid composite board material being stacked in generally parallel relation to one another and being bonded or glued together, wherein:
each layer of relatively rigid composite board material comprises first, second, third and fourth sheets of cardboard or paper, the second and fourth sheets are corrugated and the second sheet is located between the first and third sheets,
all of the sheets are glued or bonded together to form said layer of relatively rigid composite board material, and
said layers have been crushed so that the second and fourth sheets are plastically deformed to thereby form a body of cushioning material which behaves like an elastic body.

24. A body of cushioning material as claimed in claim 23 wherein the sheets of cardboard or paper have a weight in the range 85 gsm to 115 gsm.
